(19) United States
(12) Patent Application Publication
(10) Pub. No.: US 2008/0180362 A1
(43) Pub. Date: Jul. 31, 2008

(54) Plasma display device

(76) Inventors: Makoto Onozawa, Yokohama (JP); Tomokatsu Kishi, Yokosuka (JP)

Correspondence Address: MCDERMOTT WILL & EMERY LLP, 600 13TH STREET, N.W., WASHINGTON, DC, 20005-3096, US

(21) Appl. No.: 12/007,984

(22) Filed: Jan. 17, 2008

(30) Foreign Application Priority Data
Jan. 17, 2007 (JP) 2007-7929

(51) Int. Cl. G09G 3/28

(52) U.S. Cl. 345/60

(57) ABSTRACT

In the plasma display device, an electrode drive unit has a main drive circuit applying a drive pulse, a pre-drive circuit supplying control signals to the main drive circuit, and a drive control circuit supplying a drive waveform information signal to the pre-drive circuit. The main drive circuit has switches for generating the drive pulse and a charge collection capacitor. The pre-drive circuit has a control signal generation circuit which generates first to fourth control signals for controlling the first to fourth switches based on the drive waveform information signal, and a simultaneous ON prevention circuit which disables a set of the first and second, the first and fourth, and the second and third control signals to be a simultaneous ON control state respectively.

### CROSS-REFERENCE TO RELATED APPLICATIONS

This application is based upon and claims the benefit of priority from the prior Japanese Patent Application No. 2007-7929, filed on Jan. 17, 2007, the entire contents of which are incorporated herein by reference.

### BACKGROUND OF THE INVENTION

1. Field of the Invention

The present invention relates to a plasma display device, and more particularly to a plasma display device in which malfunction of a drive circuit for driving display electrodes is prevented.

2. Description of the Related Art

A plasma display device comprises a plurality of display electrodes (X and Y electrodes) which extend in the horizontal direction and a plurality of address electrodes which cross the display electrodes, and has a drive circuit for driving each electrode. Plasma display devices now popular are normally based on the Address Display-period Separated (ADS) drive system.

According to the ADS drive system, the drive control has an address period, in which data is written from the address electrodes according to the display data while scanning the display electrodes, and a sustain period, in which voltage is applied alternately to a display electrode pair after the address period. In the sustain period, a sustain pulse is applied repeatedly to a same display electrode. In other words, by the rising of a sustain pulse applied to one display electrode, the capacitor between a display electrode pair is charged, and a plasma discharge is generated between the display electrodes, and when a sustain pulse falls, the capacitor between the display electrode pair is discharged. Then by applying a sustain pulse to the other display electrode, capacitor is charged, plasma is discharged, and capacitor is discharged in a direction opposite from the above. These operations are repeated for a plurality of times. Therefore considerable power is consumed during the sustain period.

In order to conserve power consumption during the sustain period, it has been proposed that the drive circuit of display electrodes be created as a power collection circuit, so as to decrease unnecessary power consumption due to the charge and discharge of capacitor. In other words, the power collection circuit is comprised of a plurality of switch transistors, and the charge used for charging the capacitor is collected when the capacitor is discharged, and then is used for the next charging by appropriately controlling the ON/OFF of these switch transistors.

An electrode drive circuit for driving the display electrodes, on the other hand, comprises a main drive circuit which drives the display electrodes and has the above mentioned power collection function, and a pre-drive circuit which generates control signals for controlling the switch transistors of the main drive circuit. The pre-drive circuit, to which drive waveform information is supplied from the drive control circuit, generates control signals based on the drive waveform information, and the main drive circuit applies sustain pulses to the display electrodes according to the control signals from the pre-drive circuit.

In this configuration of the drive control circuit and the electrode drive circuit, it has been proposed to make the wire length for the control signals from the pre-drive circuit of the electrode drive circuit to the main drive circuit shorter than the wire length for the drive waveform information signals from the drive control circuit to the pre-drive circuit of the electrode drive circuit. An example is Japanese Patent Application Laid-Open No. 2005-300568.

By this, malfunction of the main drive circuit, due to the generation of a delay and noise on the control signals connecting the pre-drive and the main drive circuit, can be prevented.

However, if the wire configuration shown in Japanese Patent Application Laid-Open No. 2005-300568 is used, the wire length for transmitting the drive waveform information signals becomes long, and the drive waveform information may change due to noise. The wires for the drive waveform information signals are normally comprised of signal lines handling a plurality of bits, so if one of the bits is inverted by noise, the drive waveform information changes significantly, and has a major influence on control signals that the pre-drive circuit generates.

The main drive circuit of the electrode drive circuit, on the other hand, is comprised of a plurality of switches for power recovery, and if these switches are ON/OFF controlled inappropriately, an unnecessary through current is generated. Therefore an inappropriate ON/OFF control of the switches caused by the above mentioned noise to the wire for the drive waveform information must be prevented.

### SUMMARY OF THE INVENTION

With the foregoing in view, it is an object of the present invention to provide a plasma display device in which the plurality of switches of the electrode drive circuit are not inappropriately ON/OFF controlled.

To achieve the above object, a first aspect of the present invention provides a plasma display device, having a plasma display panel having a plurality of display electrodes; and an electrode drive unit which applies a drive pulse to the display electrodes a plurality of times, wherein the electrode drive unit has: a main drive circuit which applies the drive pulse to the display electrodes; a pre-drive circuit which supplies control signals to the main drive circuit; and a drive control circuit which supplies a drive waveform information signal to the pre-drive circuit. The main drive circuit has: a first switch which is connected between a first power supply and the display electrode, and turns ON when the drive pulse rises; a second switch which is connected between a second power supply lower than the first power supply, and the display electrode, and turns ON when the drive pulse falls; a charge collection capacitor; a third switch which is disposed between the charge collection capacitor and the display electrode, and turns ON when the drive pulse rises; and a fourth switch which is disposed between the display electrode and the charge collection capacitor, and turns ON when the drive pulse falls. The pre-drive circuit has: a control signal generation circuit which generates first to fourth control signals for controlling the first to fourth switches based on the drive waveform information signal; and a simultaneous ON prevention circuit which disables at least a set of the first and second control signals, a set of the first and fourth control signals, and a set of the second and third control signals, out of the first to fourth control signals, to be a simultaneous ON control state respectively, and supplies the first to fourth control signals to the main drive circuit.

According to the first aspect, the simultaneous ON prevention circuit is disposed in the pre-drive circuit, so it can be prevented that a set of the first and second switches, a set of the first and fourth switches or a set of the second and third switches of the main drive circuit simultaneously turn ON, and a through current is generated.

In the first aspect, it is preferable that a wire length for the control signal between the simultaneous ON prevention circuit and the main drive circuit is shorter than a wire length for the drive waveform information signal between the drive control circuit and the pre-drive circuit. Or it is preferable that the simultaneous ON prevention circuit is disposed adjacent to the main drive circuit so that the wire length for the control signal becomes short. According to these preferred embodiments, at least a set of the first and second control signals, a set of the first and fourth control signals, or a set of the second and third control signals, becoming simultaneously ON control state, is disabled, just before the first to fourth control signals are supplied to the main drive. By this, the generation of a through current in the main drive circuit can be prevented even if noise is superimposed on the signal wire.

In the first aspect it is preferable that the simultaneous ON prevention circuit further has: a logic circuit which disables any combination of control signals to be a simultaneous ON control state, except for the simultaneous ON control state of the first and third control signals and the simultaneous ON control state of the second and fourth control signals.

To achieve the above object, a second aspect of the present invention provides a plasma display device, having: a plasma display panel having a plurality of display electrodes; and an electrode drive unit which applies a drive pulse to the display electrodes a plurality of times. The electrode drive unit has: a main drive circuit which applies a drive pulse to the display electrode; and a pre-drive circuit which supplies a control signal to the main drive circuit. The main drive circuit has: a first switch which is connected between a first power supply and the display electrode, and turns ON when the drive pulse rises; a second switch which is connected between a second power supply lower than the first power supply, and the display electrode, and turns ON when the drive pulse falls; a charge collection capacitor; a third switch which is disposed between the charge collection capacitor and the display electrode, and turns ON when the drive pulse rises; and a fourth switch which is disposed between the display electrode and the charge collection capacitor, and turns ON when the drive pulse falls, and the pre-drive circuit has: a control signal generation circuit which generates first to fourth control signals for controlling the first to fourth switches based on the drive waveform information signal; and a simultaneous ON prevention circuit, which disables at least a set of the first and second control signals, a set of the first and fourth control signals, and a set of the second and third control signals, out of the first to fourth control signals, to be a simultaneous ON control state respectively, and supplies the first to fourth control signals to the main drive circuit.

In the first or second aspects, it is preferable that the simultaneous ON prevent circuit: outputs the first control signal in the OFF control state, even if the first control signal, generated by the control signal generation circuit, is in the ON control state, when either the second or fourth control signal, generated by the control signal generation circuit, is in the ON control state; outputs the second control signal in the OFF control state, even if the second control signal, generated by the control signal generation circuit, is in the ON control state, when either the first or third control signal, generated by the control signal generation circuit, is in the ON control state; outputs the third control signal in the OFF control state, even if the third control signal, generated by the control signal generation circuit, is in the ON control state, when either the second or fourth control signal, generated by the control signal generation circuit, is in the ON control state; and outputs the fourth control signal in the OFF control state, even if the fourth control signal, generated by the control signal generation circuit, is in the ON control state, when either the first or third control signal, generated by the control signal generation circuit, is in the ON control state.

To achieve the above object, a third aspect of the present invention provides a plasma display device, having: a plasma display panel having a plurality of display electrodes; and an electrode drive unit which applies a drive pulse to the display electrodes a plurality of times, wherein the electrode drive unit has: a main drive circuit which applies a drive pulse to the display electrode; a pre-drive circuit which supplies a control signal to the main drive circuit; and a drive control circuit which supplies a drive waveform information signal to the pre-drive circuit, the main drive circuit has: a charge collection capacitor; and a plurality of switches which generate the drive pulse, the pre-drive circuit has: a control signal generation circuit which generates a plurality of control signals for controlling the plurality of switches based on the drive waveform information signal; and a simultaneous ON prevention circuit which disables at least a predetermined control signal pair out of the plurality of control signals to be a simultaneous ON control state, and supplies the plurality of control signals to the main drive circuit, and a wire length for the control signal between the simultaneous ON prevention circuit and the main drive circuit is shorter than the wire length for the drive waveform information signal between the drive control circuit and the pre-drive circuit.

According to the present invention, a plurality of switches of the electrode drive circuit being ON-OFF controlled inappropriately can be effectively prevented, and the generation of a through current can be prevented with certainty.

### BRIEF DESCRIPTION OF THE DRAWINGS

FIG. 1 is a block diagram depicting a plasma display device according to the present embodiment;

FIG. 2 is another block diagram depicting a plasma display device according to the present embodiment;

FIG. 3 is a block diagram depicting the X and Y electrode drive circuit 24 and 28;

FIG. 4 is a drive waveform diagram depicting the operation of a main drive circuit;

FIGS. 5A to 5C are tables showing the logical expressions of a simultaneous ON prevention circuit;

FIG. 6 is a logical circuit diagram of the simultaneous ON prevention circuit;

FIG. 7 is a second block diagram depicting the X and Y electrode drive circuit according to the present embodiment;

FIG. 8 is a third block diagram depicting the X and Y electrode drive circuit according to the present embodiment;

FIG. 9 is a diagram depicting an example of the insulation circuit, modulation circuit and demodulation circuit in FIG. 8;

FIG. 10 is a fourth block diagram depicting the X and Y electrode drive circuit according to the present embodiment; and

FIG. 11 is a fifth block diagram depicting the X and Y electrode drive circuit according to the present embodiment.

### DESCRIPTION OF THE PREFERRED EMBODIMENTS

Embodiments of the present invention will now be described with reference to the drawings. The technical scope of the present invention, however, is not limited to these embodiments, but covers matters stated in the Claims and equivalents thereof.

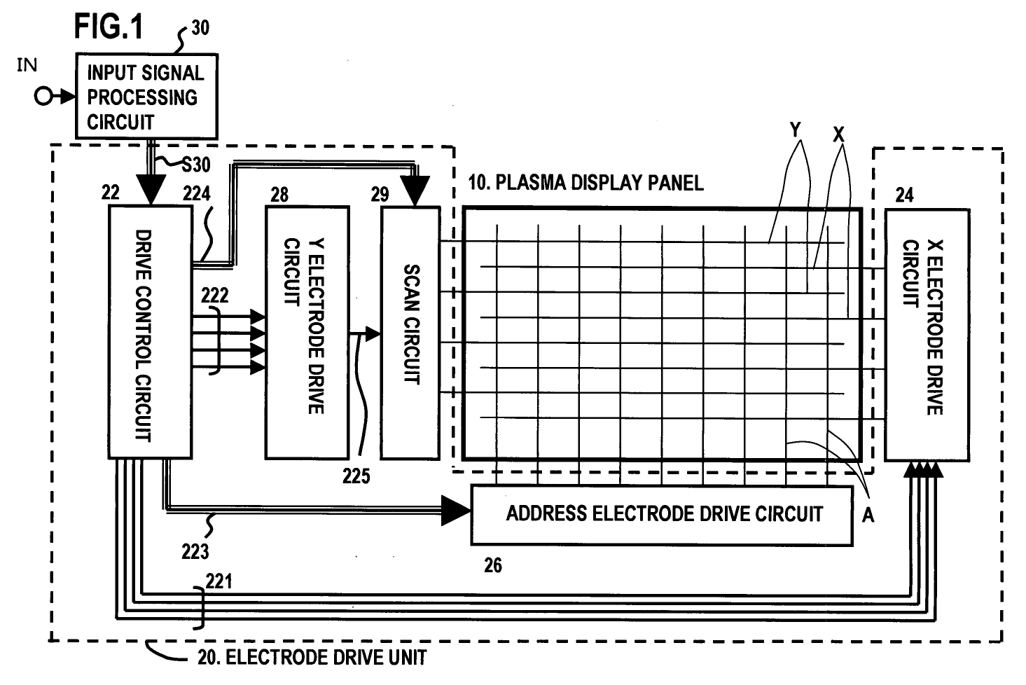

FIG. 1 is a block diagram of a plasma display device according to an embodiment of the present invention. The plasma display device comprises: a plasma display panel 10 which is comprised of a plurality of display electrodes X and Y extending in the horizontal direction, and a plurality of address electrodes A extending in the vertical direction, crossing the display electrodes X and Y; an electrode drive unit 20 which applies a drives pulse on and drives the electrodes of the panel; and an input signal processing circuit 30 which image-processes the video signals IN that are input from a TV tuner or a DVD player, and generates image signals for the plasma display panel. The input signal processing circuit generates an image digital signal for each frame, for example, as an image signal S30, and supplies it to a drive control circuit 22 of the electrode drive unit 20. In the plasma display panel 10, the display electrodes X and Y are formed on a display side substrate, the address electrodes A are formed on a rear substrate, and these substrates are disposed with a plasma discharge space there between.

The drive control for the plasma display panel 10 has a reset period for performing reset discharge between the display electrode pair X and Y and for adjusting wall charges of the entire panel, an address period for applying an address discharge pulse from address electrodes while scanning the Y electrodes, and for forming wall charges in cells, and a sustain period for applying a drive pulse alternately to the X and Y electrodes of the display electrode pair to generate plasma discharge, and for outputting a desired brightness from cells where wall charges were stored in the address period.

The electrode drive unit 20 has the drive control circuit 22 which generates control signals 221, 222, 223 and 224 for driving the plasma display panel 10 from a frame image signal S30, an X electrode drive circuit 24 which applies sustain pulses to the display electrodes X according to the control signal 221, an address electrode drive circuit 26 which applies address discharge pulses to the address electrodes X, a Y electrode drive circuit 28 which applies scan pulses and sustain pulses 225 to the display electrodes Y according to the control signal 222, and a scan circuit 29 which selects a Y electrode to which the scan pulse is applied during the address period.

The control signal 221 and 222 is comprised of four control signals for controlling the four switch transistors of a main drive circuit in the X electrode drive circuit 24 and Y electrode drive circuit 28. In the drive control circuit 22, a pre-drive circuit, which is not illustrated, is disposed, and the pre-drive circuit generates four control signals 221 and 222 for X electrode driving and Y electrode driving respectively, and supplies them to the X and Y electrode drive circuit 24 and 28. Switch elements in the main drive circuit, which are not illustrated, of the X and Y electrode drive circuit are ON/OFF controlled responding to the control signals, and apply a drive pulse, such as a sustain pulse, to the X and Y electrode. The control signals will be described later.

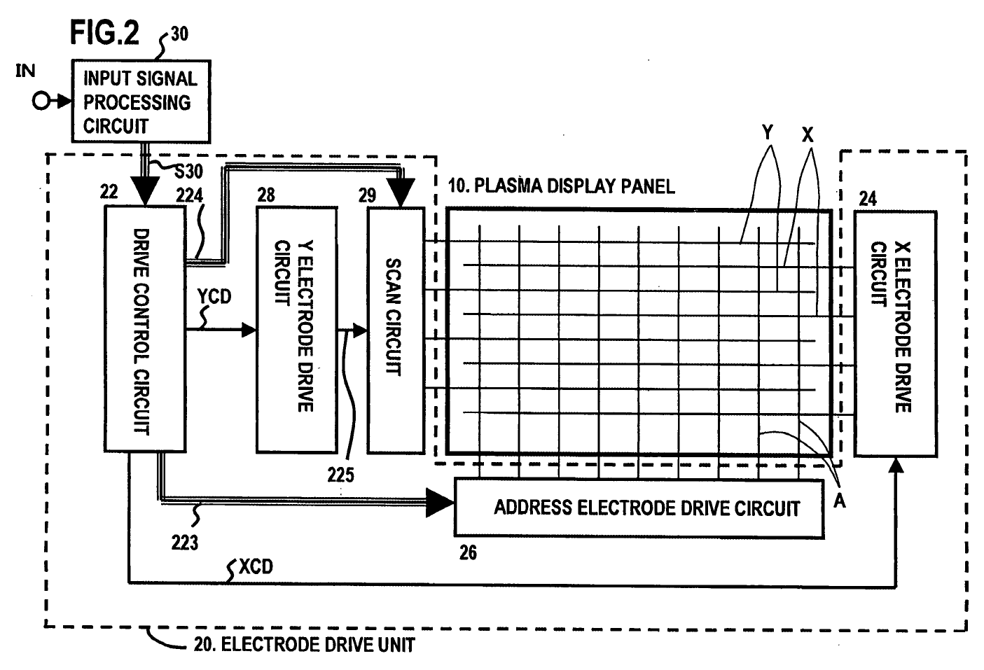

FIG. 2 is another block diagram of a plasma display device according to the present embodiment. This plasma display device comprises a plasma display panel 10 and an electrode drive unit 20, just like FIG. 1. The difference from FIG. 1 is that a drive control circuit 22 supplies a control command signal XCD and YCD to an X electrode drive circuit 24 and Y electrode drive circuit 28 respectively, and a pre-drive circuit, which is not illustrated, in the X and Y electrode drive circuits, generates the control signal based on the control command signal. The control command signal XCD and YCD includes a waveform information signal of a drive pulse, in addition to drive control information. The drive waveform information signal is a data signal comprised of a plurality of bits which includes a rise timing and fall timing of a drive pulse, for example. Therefore the control command signal XCD and YCD is comprised of a plurality of bits which are output serially on one line. In FIG. 2, the rest of the configuration is the same as FIG. 1.

In the case of the configuration in FIG. 2, a wire length for the control signals, from the pre-drive circuit to the main drive circuit in the X electrode drive circuit 24, can be sufficiently shorter than a wire length for the control command signal XCD, from the drive control circuit 22 to the X electrode drive circuit 24. Since the control command signal can be implemented by one wire, the number of signal lines in the plasma display device can be decreased. Hence cost can be decreased. If noise is superimposed on the control command signals XCD and YCD, however, it is expected that the drive waveform information signal changes, and an inappropriate drive pulse is generated.

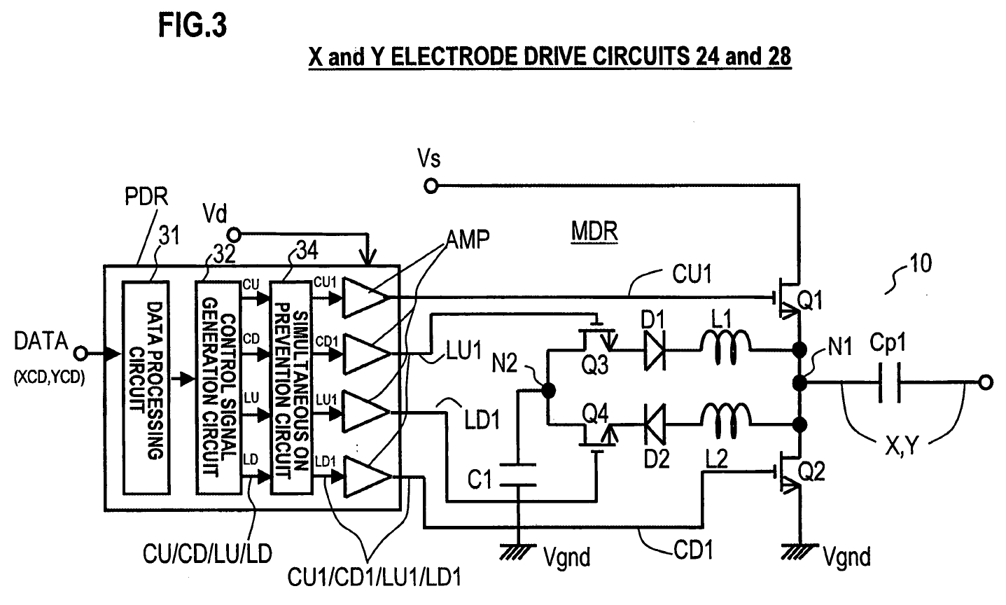

FIG. 3 is a block diagram depicting the X and Y electrode drive circuit according to the present embodiment. The X and Y electrode drive circuit 24 and 28 comprises a pre-drive circuit PDR where command signal XCD and YCD, including the waveform information of the drive pulse, is input, and four control signals CU, CD, LU and LD are generated, and a main drive circuit MDR, which further comprises a plurality of switches Q1 to Q4, which are ON/OFF controlled according to the control signals, and a capacitor C1 for collecting charges, and applies a drive pulse to X and Y electrodes.

The command signal XCD and YCD has 8-bit data which indicates a rise timing of the drive pulse, and 8-bit data which indicates a fall timing (or pulse width) of the drive pulse, for example. The pre-drive circuit PDR further has a data processing circuit 31, where the command signal XCD and YCD is input and data to indicate the above mentioned timing is separated, for example, a control signal generation circuit 32 which generates the four control signals CU, CD, LU and LD, responding to the output of the data processing circuit 31, a simultaneous ON prevention circuit 34, which prevents the simultaneous ON control state of the four control signals CU, CD, LU and LD, except the simultaneous ON control state of CU and LU, and the simultaneous ON control state of CD and LD, and an amplifier AMP which amplifies the four control signals CU1, CD1, LU1 and LD1, which are output from the simultaneous ON prevention circuit 34 respectively.

In the main drive circuit MDR, a first switch Q1, which turns ON when the drive pulse rises, and a second switch Q2, which turns ON when the drive pulse falls, are connected between a first power supply Vs, which supplies high drive pulse voltage, such as a sustain pulse, and a second power supply (e.g. ground) Vgnd, which is lower than the first power supply Vs. A charging circuit, comprised of a third switch Q3, which turns ON when the drive pulse rises, a diode D1 and an inductance L1, is between an output node N1, connected to the X and Y electrode, and a charge collection capacitor C1. A charge collection circuit comprised of a fourth switch Q4, which turns ON when the drive pulse falls, a diode D2 and an inductance L2, is also between the output node N1 and the charge collection capacitor C1. The above mentioned four switches Q1 to Q4 comprise N channel transistors, and the first to fourth control signals CU1, CD1, LU1 and LD1 are applied to the respective gates. The switch transistors Q1 to Q4 turn ON when these control signals are H level (data 1), and turn OFF when the control signals are L level (data 0) respectively. In other words, H level of the control signal corresponds to the ON control state, and L level corresponds to the OFF control state.

A parasitic capacitor Cp1 exists between the X and Y electrodes of the plasma display panel 10. Therefore if a sustain pulse is applied to the X or Y electrode, the switch Q1 is turned ON when the pulse rises, the parasitic capacitor Cp1 is charged by the first power supply Vs, then plasma discharge is generated due to the potential difference, which is more than the discharge threshold voltage, between the X and Y electrodes, and current required for this discharge is supplied from the first power supply Vs, then the switch Q1 is turned OFF and the switch Q2 is turned ON when the pulse falls, and the charge in the parasitic capacitor Cp1 is discharged.

Since the drive pulse, such as the sustain pulse, is repeatedly applied for a plurality of times, the switch Q4 is turned ON when the pulse falls, and the charge in the parasitic capacitor Cp1 is collected to the charge collection capacitor C1 via the inductance L2, diode D2 and switch Q4, then the switch Q3 is turned ON when the pulse rises, and the charge in the charge collection capacitor C1 is transferred to the parasitic capacitor Cp1 via the switch Q3, diode D1 and inductance L1. By providing to the main drive circuit MDR, the charge collection function, which collects the charge stored in the parasitic capacitor Cp1 between the electrodes and uses it when the next pulse is applied, the power required for the drive pulse which is repeated applied, particularly the power required for changing the parasitic capacitor Cp1, can be conserved.

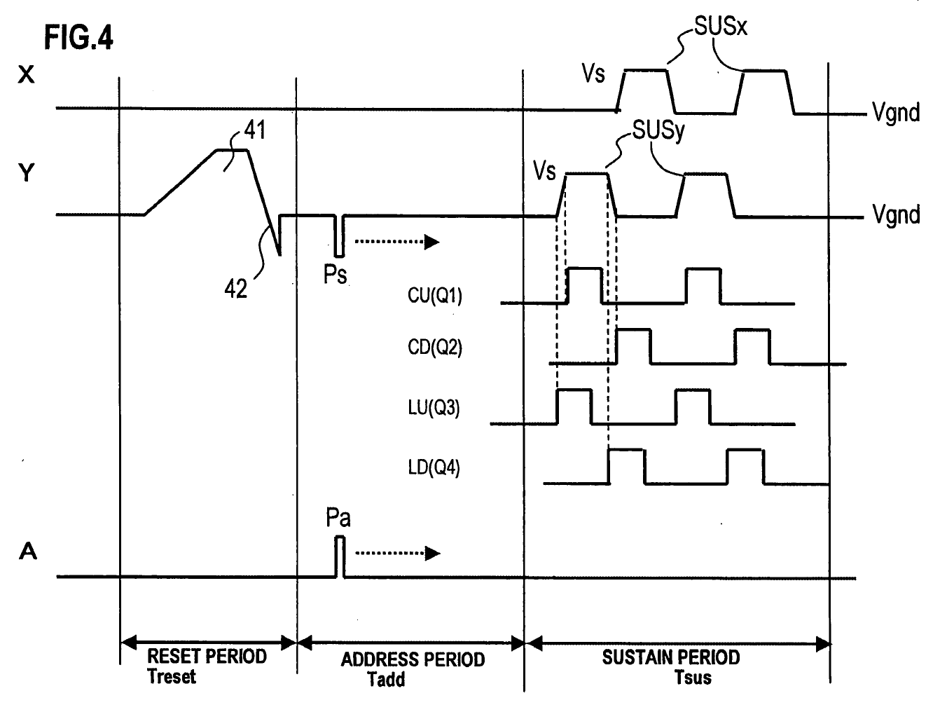

FIG. 4 is a drive waveform diagram depicting operation of the main drive circuit. FIG. 4 shows the signal waveforms of the display electrodes X and Y and the address electrode A, and the signal waveforms of the four control signals CU, CD, LU and LD in a sustain period. Here the signal waveforms of the four control signals CU, CD, LU and LD are shown corresponding to a sustain pulse SUSy of the Y electrodes, but the control signals corresponding to a sustain pulse SUSx of the X electrodes are also the same.

In the reset period Treset, the X electrode is maintained at the second power supply Vgnd level, a positive polarity pulse 41 and a negative polarity pulse 42 are applied to the Y electrode, so as to generate a weak reset discharge between the X and Y electrodes, and the amount of wall charge in the discharge cell area is adjusted to be uniform on the entire panel surface.

Then in an address period Tadd, a scan pulse Ps is sequentially applied to the Y electrodes, and synchronizing this operation, an address pulse Pa corresponding to the image data is applied to a plurality of address electrodes A. As a result, a cell where the address pulse Pa is applied generates an address discharge, and forms a wall charge.

Then in the sustain period Tsus, the sustain pulses SUSy and SUSx are alternately applied to the Y electrode and the X electrode, and an electric field is applied alternately between the Y and X electrodes. For the pulse voltage Vs of the sustain pulse, the effective applied voltage, which is the result when the voltage, due to the wall charge generated by the address discharge, is added to Vs, exceeds a threshold voltage of plasma discharge, but the voltage Vs which has no voltage, due to wall charge, is controlled at a level which does not exceed the threshold voltage. Therefore only cells where address discharge is generated during the address period repeat the sustain discharge by an applied sustain pulse. By changing the number of sustain pulses, brightness in the sustain period can be controlled. Normally a desired brightness display is enabled by positioning a plurality of sub-fields having a number of sustain pulses weighted in a prescribed way in a time series, and executing a sustain discharge in a desired combination of sub-fields.

Now applying the sustain pulse SYSy to the Y electrode and the four control signals CU, CD, LU and LD will be described. The following description, however, can also be applied to the relationship between the sustain pulse SUSx to the X electrode and the four control signals. As described above, after the main drive circuit MDR repeats a charge and discharge of the parasitic capacitor Cp1 between the X and Y electrodes on the panel, a node N2 of the capacitor C1 in the charge collected state is converged to a mid-potential Vs/2 between the first and second power supplies Vs and Vgnd. It is assumed that the node N2 is in the charge collected state Vs/2.

First at a rise timing of the sustain pulse SUSy, the third control signal LU becomes H level. Responding to this, the third switch Q3 turns ON, the charge in the capacitor C1 is transferred to the node N1 via the transistor Q3, diode D1 and inductor L1, and is charged to the parasitic capacitor Cp1. Even after the potential of the node N1 rises and reaches the level lower than the potential of the node N2 by the amount of forward voltage of the diode D1, charging to the parasitic capacitor Cp1 continues because of the function of an LC resonance circuit created by the inductor L1 and the parasitic capacitor Cp1, and the node N1 rises up to a potential of about 70% of the first power supply Vs.

At this timing of the node N1 rising up to a 70% potential, the first control signal CU becomes H level, and the transistor Q1, which is the first switch, turns ON. Because of this, the parasitic capacitor Cp1 is further charged by the current from the first power supply Vs. When the effective applied voltage between the X and Y electrodes exceeds the discharge threshold voltage, plasma discharge is generated, and current required for this plasma discharge is supplied from the first power supply Vs via the transistor Q1.

At a fall timing of the sustain pulse SUSy, on the other hand, the fourth control signal LD becomes H level. Responding to this, the fourth switch Q4 turns ON, the charge stored in the parasitic capacitor Cp1, between the X and Y electrodes of the panel, is transferred to the node N2 via the inductor L2, diode D2 and fourth transistor Q4, and the capacitor C1 collects the charge. Just like the case of the rise of the sustain pulse SUSy, the potential of the node N1 drops down to about 30% of the first power supply Vs because of the function of the LC resonance circuit created by the inductor L2 and the parasitic capacitor Cp1.

At this timing of the node N1 dropping down to a 30% potential, the second control signal CD becomes H level, and the transistor Q2, which is the second switch, turns ON. Because of this, the parasitic capacitor Cp1 discharges to the second power supply Vgnd, and the node N1 becomes the level of the second power supply Vgnd. Then the above mentioned rise and fall operations of the pulse are repeated.

As described above, when the drive pulse rises, the main drive circuit MDR turns the third switch Q3 ON to store the charge in the charge collection capacitor C1 into the parasitic capacitor Cp1 of the panel, then turns the first switch Q1 ON to raise the X and Y electrodes to the potential of the first power supply Vs, and supplies the plasma discharge current. When the drive pulse falls, the main drive circuit MDR turns the fourth switch Q4 ON to collect the charge of the parasitic capacitor Cp1 of the panel to the charge collection capacitor C1, then turns ON the second switch Q2 to drop the X and Y electrode down to the potential of the second power supply Vgnd.

In this way, in the main drive circuit, a simultaneous ON state of the first and third switches Q1 and Q3, and a simultaneous ON state of the second and fourth switches Q2 and Q4 could occur. However a simultaneous ON state of the first and second switches Q1 and Q2, a simultaneous ON state of the first and fourth switches Q1 and Q4, and a simultaneous ON state of the second and third switches Q2 and Q3 should not occur. These simultaneous ON states, which generate unnecessary current, waste power, and cause inappropriate charging and discharging of the charge collection capacitor, are not desirable.

Hence in the present embodiment, the simultaneous ON prevention circuit 34 is disposed immediately before the main drive circuit MDR, so as to disable a plurality of control signals out of the four control signals CU, CD, LU and LD to be a simultaneous ON control state, except the cases of the first and third control signals CU and LU becoming ON control state (H level), and the second and fourth control signals CD and LD becoming simultaneous ON control state (H level). Therefore, the simultaneous ON prevention circuit 34 generates control signals CU1, CD1, LU1 and LD1, where the above mentioned simultaneous ON control states are removed, from the four control signals CU, CD, LU and LD, and supplies them to the gates of the four switch elements Q1 to Q4 of the main drive circuit via the amplifier AMP.

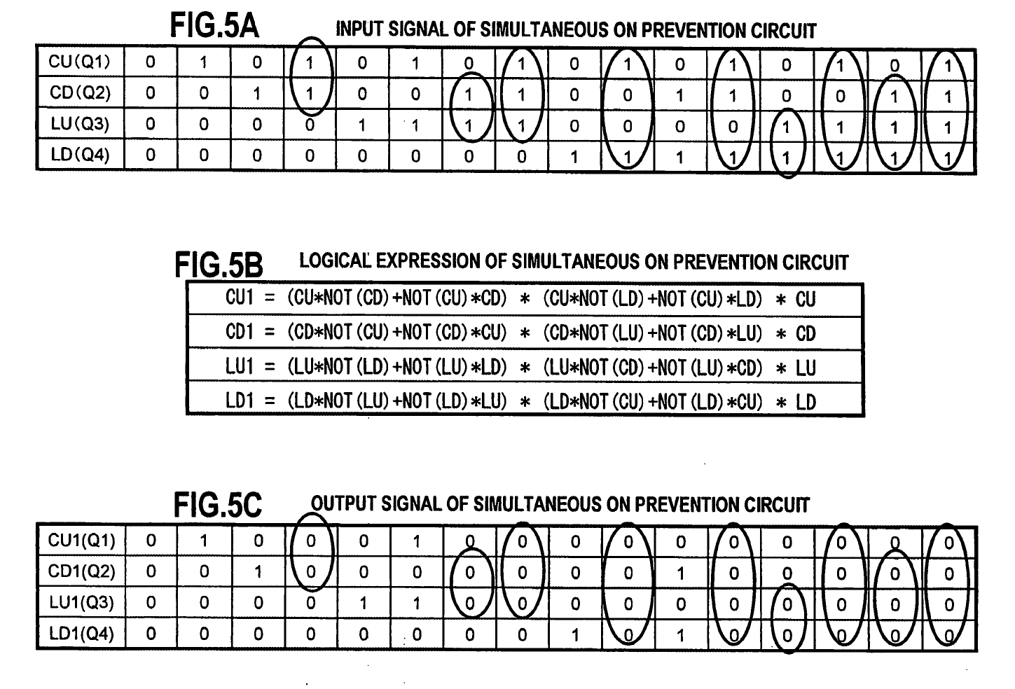

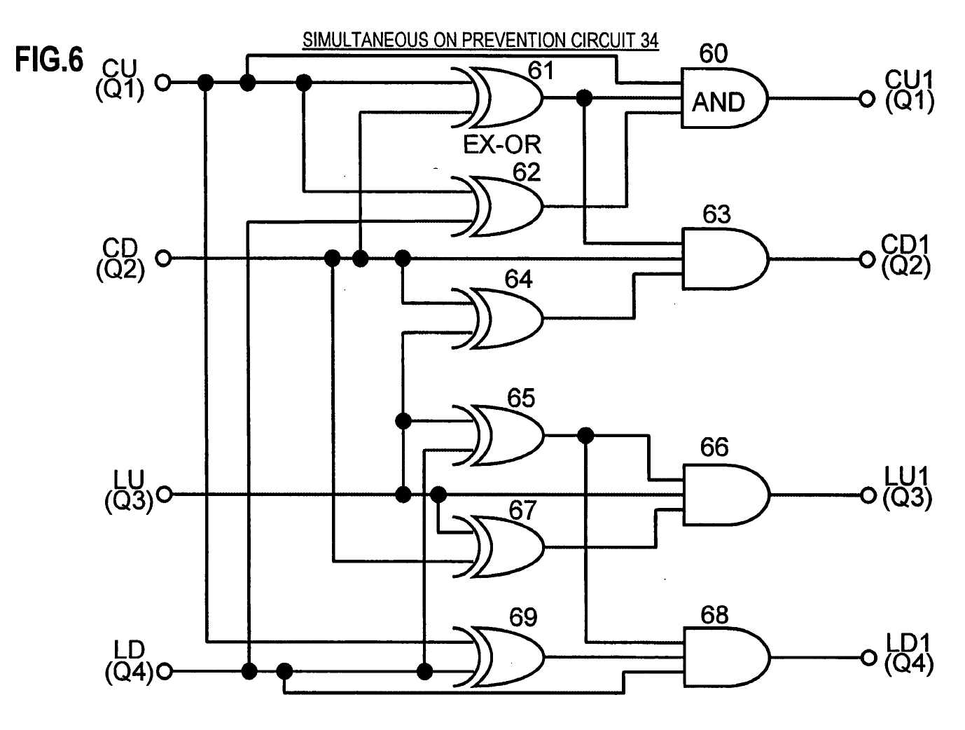

FIGS. 5A to 5C are tables showing the logical expressions of the simultaneous ON prevention circuit. FIG. 6 is a logical circuit diagram of the simultaneous ON prevention circuit. FIG. 5A is a table showing all the combinations of the four control signals CU, CD, LU and LD, which are input to the simultaneous ON prevention circuit 34. FIG. 5B is a table showing the logical expressions of the simultaneous ON prevention circuit 34. FIG. 5C is a table showing the four control signals CU1, CD1, LU1 and LD1, which are output from the simultaneous ON prevention circuit 34. The simultaneous ON control states to be prevented are indicated by the ellipses in FIG. 5.

According to the logical expressions of FIG. 5B, the first control signal CU1 is a logical product of the EOR of the first and second input control signals CU and CD, the EOR of the first and fourth input control signals CU and LD, and the first input signal CU. In other words, if the second and fourth input control signals CD and LD are both L level when the first input control signal CU is H, the two EORs become H level, so the first output control signal CU1 becomes H, hence even if the first input control signal CU is H, one of the two EORs becomes L level if one of the second and fourth input control signals CD and LD is H level, so the first output control signal CU1 becomes L. As a result, the first and second control signals CU1 and CD1 simultaneously becoming the ON control state (H level), and the first and fourth control signals CU1 and LD1 simultaneously becoming the ON control state can be prevented. Therefore if one of the second and fourth input control signals CD and LD becomes H level due to the influence of noise when the first input control signal CU is H, the first output control signal CU1 becomes L.

The EOR gates 61 and 62 and the AND gate 60 in FIG. 6 are the logical circuits corresponding to the logical expressions for generating the first control signal CU1 in FIG. 5B.

According to the logical expressions of FIG. 5B, the second control signal CD1 is a logical product of the EOR of the first and second input control signals CU and CD, the EOR of the second and third input signals CD and LU, and the second input control signal CD. In other words, if the first and third input control signals CU and LU are both L level when the second input control signal CD is H, the second output control signal CD1 becomes H, hence even if the second input control signal CD is H, the second output control signal CD1 becomes L if one of the first and third input control signals CU and LU is H level. As a result, the first and second control signals CU1 and CD1 simultaneously becoming the ON control state (H level) and the second and third control signals CD1 and LU1 simultaneously becoming the ON control state can be prevented. Therefore if one of the first and third input control signals CU and LU becomes H level due to the influence of noise when the second input control signal CD is H, the second output control signal CD1 becomes L.

The EOR gates 61 and 64 and the AND gate 63 in FIG. 6 are the logical circuits corresponding to the logical expressions for generating the second control signal CD1 in FIG. 5B.

According to the logical expressions of FIG. 5B, the third control signal LU1 is a logical product of the EOR of the third and fourth input control signals LU and LD, the EOR of the third and second input control signals LU and CD, and the third input control signal LU. In other words, if the second and fourth input control signals CD and LD are both L level when the third input control signal LU is H, the third output control signal LU1 becomes H, hence even if the third input control signal LU is H, the third output control signal LU1 becomes L if one of the second and fourth input control signals CD and LD is H level. As a result, the third and fourth control signals LU1 and LD1 simultaneously becoming the ON control state, and the second and third control signals CD1 and LU1 simultaneously becoming the ON state (H level) can be prevented. Therefore if one of the second and fourth input control signals CD and LD becomes H level due to the influence of noise when the third input control signal LU is H, the third output control signal LU1 becomes L.

The EOR gates 65 and 67 and the AND gate 66 in FIG. 6 are the logical circuits corresponding to the logical expressions for generating the third control signal LU1 in FIG. 5B.

Finally, according to the logical expressions of FIG. 5B, the fourth control signal LD1 is a logical product of the EOR of the third and fourth input control signals LD and LU, the EOR of the fourth and first input control signals LD and CU, and the fourth input control signal LD. In other words, if the first and third input control signals CU and LU are both L levels when the fourth input control signal LD is H, the fourth output control signal LD1 becomes H, hence even if the fourth input control signal LD is H, the fourth output control signal LD1 becomes L if one of the first and third input control signals CU and LU is H level. As a result, the fourth and third control signals LU1 and LD1 simultaneously becoming the ON control state (H level), and the fourth and first control signals LD1 and CU1 simultaneously becoming the ON control state can be prevented. Therefore if one of the first and third input control signals CU and LU becomes H level due to the influence of noise when the fourth input control signal LD is H, the fourth output control signal LD1 becomes L.

The EOR gates 65 and 69 and the AND gate 68 in FIG. 6 are the logical circuits corresponding to the logical expressions for generating the fourth control signal LD1 in FIG. 5B.

Only one of the EOR gates 62 and 69 in FIG. 6 may be provided, and only one of the EOR gates 64 and 67 may be provided.

As described above, the simultaneous ON prevention circuit 34 prevents control signals from simultaneously becoming ON control state, except the cases of the first and third control signals CU1 and LU1 simultaneously becoming the ON control state (H level) and the second and fourth control signals CD1 and LD1 simultaneously becoming the ON control state (H level). In some cases, a simultaneous ON control state may occur in the output of the control signal generation circuit 32 due to the generation of noise, even if the control signal generation circuit 32 is designed to generate control signals, so as to prevent the generation of the above mentioned simultaneous ON control states. But even if this simultaneous ON control state is generated, the simultaneous ON prevention circuit 34 can prevent such a state. Therefore an inappropriate operation of the main driver circuit can be prevented. It is sufficient that the simultaneous ON prevention circuit 34 can prevent at least a set of the first and second control signals, a set of the first and fourth control signals, and a set of the second and third control signals, becoming the simultaneous ON control state.

The X and Y electrode drive circuit in FIG. 3 corresponds to the X and Y electrode drive circuit 24 and 28 in FIG. 2. In the case of the configuration of the plasma display device in FIG. 2, the drive control circuit 22 supplies a waveform information signal (a plurality of bits) of the drive pulse to the X and Y electrode drive circuit 24 and 28 via a single command wire XCD and YCD. Therefore if a noise is superimposed on the command wire XCD and YCD, a bit of the plurality of bits of the waveform information signal tends to be inverted. If a bit, particularly a higher bit, of the plurality of bits is inverted, the waveform information changes considerably. So by disposing the simultaneous ON prevention circuit 34 in a stage immediately before and adjacent to the main drive circuit MDR in the X and Y electrode drive circuit 24 and 28 in the plasma display device with the configuration in FIG. 2, a plurality of control signals simultaneously becoming the ON control state, except in the cases of the first and third control signals CU and LU simultaneously becoming the ON control state, and the second and fourth control signals CD and LD simultaneously becoming the ON control state, can be prevented even if the drive pulse waveform information inappropriately changes by the above mentioned noise.

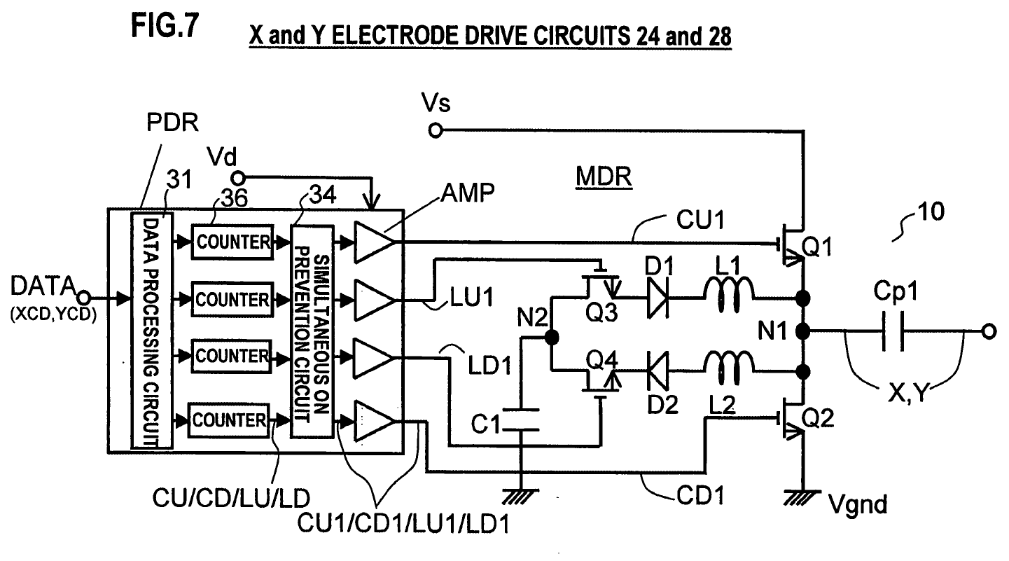

FIG. 7 is a second block diagram depicting an X and Y electrode drive circuit according to the present embodiment. In the electrode drive circuit in FIG. 7, the control signal generation circuit 32 of the electrode drive circuit in FIG. 3 is comprised of four counters 36. In counter 36, a number of first clocks from a reference timing to a drive pulse rise timing, and a number of second clocks from the rise timing to the fall timing (number of clocks corresponding to the pulse width) are used based on the reference timing, which is not illustrated, from the data processing circuit 31, and the control signals CU, CD, LU and LD rise at a timing when the first number of clocks are counted, and then the control signals CU, CD, LU and LD fall at a timing when the second number of clocks are counted. The rest of the configuration is the same as FIG. 3. It is also the same that the pre-drive circuit PDR and the main drive circuit MDR in FIG. 7 can be applied to both of the plasma display devices in FIG. 1 and FIG. 2.

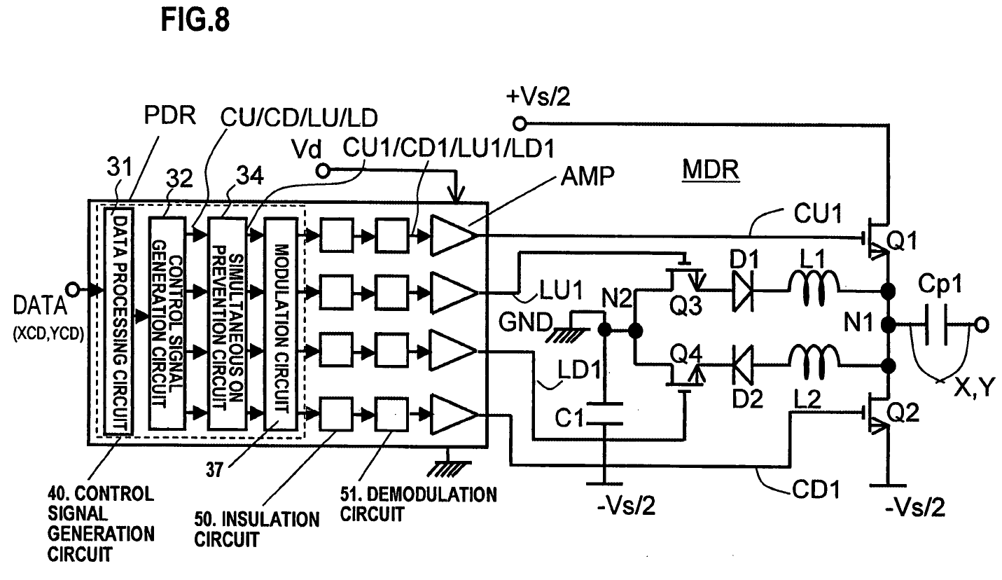

FIG. 8 is a third block diagram depicting an X and Y electrode drive circuit according to the present embodiment. In the electrode drive circuit, a pre-drive circuit PDR is connected to a power supply Vd and a ground power supply, and a main drive circuit MDR is connected to a first power supply +Vs/2 and a second power supply −Vs/2 which is lower than the first power supply. In other words, a sustain pulse, which is applied to the X and Y electrode of the plasma display panel, rises from the second power supply Vs/2, other than the ground power supply, to the first power supply +Vs/2, and falls to the second power supply −Vs/2. When the sustain pulse rises and falls, the charge current and the discharge current of the parasitic capacitor Cp1 are generated, and this configuration prevents the generation of a large noise in the ground power supply by the charge current and the discharge current flowing into the ground power supply. The ground power supply is the reference power supply for the pre-drive circuit PDR and the drive control circuit 22.

Therefore in the electrode drive circuit in FIG. 8, an insulation circuit 50 for enabling the conversion of the power supply level is disposed between a control signal generation circuit 40 in the pre-drive circuit PDR and the main drive circuit MDR. This insulation circuit 50 is an i-coupler and an insulation type signal transmission circuit implemented by a transformer circuit and a photo coupler circuit, for example. Because of this, a modulation circuit 37 and a demodulation circuit 51 are disposed before and after the insulation circuit 50.

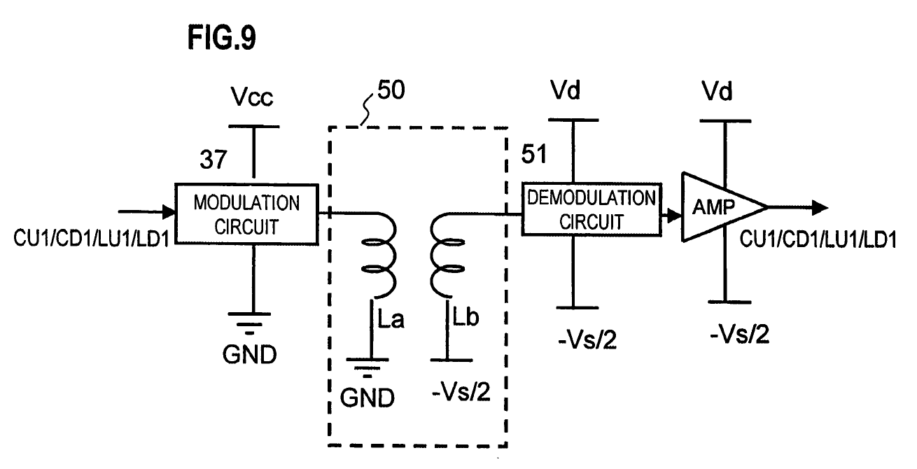

FIG. 9 is a diagram depicting an example of the insulation circuit, modulation circuit and demodulation circuit in FIG. 8. The modulation circuit 37 is connected to a power supply Vcc and GND, and modulates control signals CU1, CD1, LU1 and LD1 (pulse signals between GND and Vcc) which are output by the simultaneous ON prevention circuit to high frequency signals. A primary coil of the insulation circuit 50 is connected to the ground power supply GND, and a secondary coil Lb is connected to a second power supply −Vs/2. High frequency signals generated by the modulation circuit flow through the primary coil La of the insulation circuit 50, and generate an electro motive force corresponding to the high frequency signals. Induced by this, high frequency signals are generated in the secondary coil Lb of the insulation circuit 50. Then the demodulation circuit 51 demodulates the high frequency signals generated by the secondary coil Lb. The demodulation circuit 51 is connected to the first and second power supplies +Vs/2 and −Vs/2, generates control signals CU1, CD1, LU1 and LD1 (pulse signals between +Vs/2 and −Vs/2) corresponding to the power supply level thereof, and outputs the control signals to the main drive circuit MDR via the amplifier AMP.

In the main drive circuit MDR, first and second transistors Q1 and Q2 are connected to the first power supply +Vs/2 and the second power supply −Vs/2 respectively, and a node N2 is connected to the ground power supply GND. The charge collection capacitor C1 can be replaced with a coupling capacitor, which is disposed between the ground power supply GND and the second power supply −Vs/2. By using this circuit configuration, a drive pulse, of which L level is −Vs/2 and H level is +Vs/2, can be generated in the node N1 by an operation the same as FIG. 3. The control signals CU1, CD1, LU1 and LD1, which control the ON state of the first to fourth transistors Q1 to Q4, are converted into control pulses corresponding to the first power supply +Vs/2 and the second power supply −Vs/2 by the modulation circuit 37, insulation circuit 50 and demodulation circuit 51. As a result, the ON state of the first to fourth transistors Q1 to Q4 is appropriately controlled by the control signals CU1, CD1, LU1 and LD1, of which power supply level was converted.

### [Example of Applying X and Y Electrode Drive Circuit to FIG. 1]

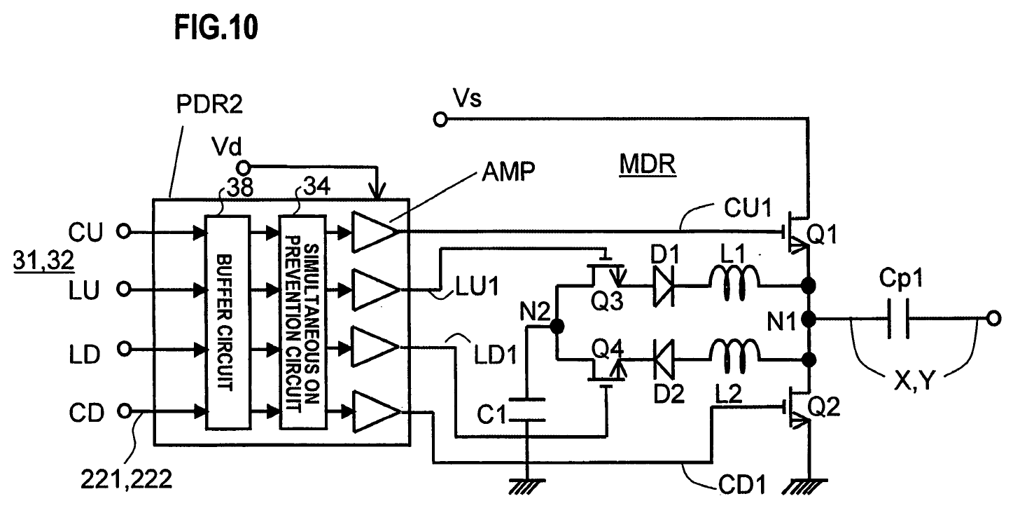

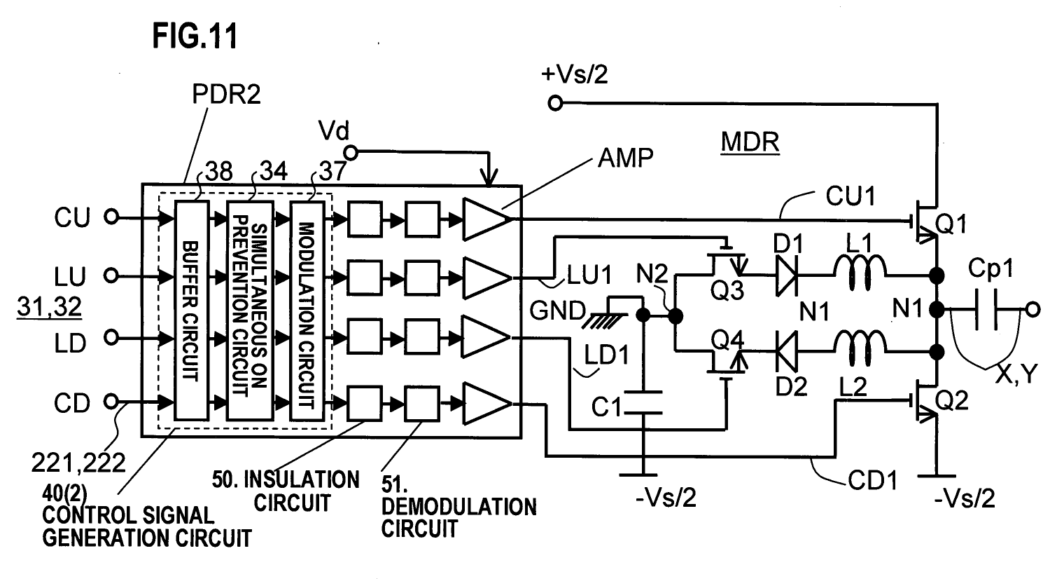

It was described that the X and Y electrode drive circuit in FIG. 3 is applied to the plasma display device in FIG. 2. However the X and Y electrode drive circuit in FIG. 3 can also be applied to FIG. 1. If it is applied to FIG. 1, then the data signal processing circuit 31 and the control signal generation circuit 32 in the pre-drive circuit PDR are disposed in the drive control circuit 22, and the simultaneous ON prevention circuit 34 and the amplifier AMP are disposed in a stage immediately before and adjacent to the main drive circuit MDR in the X and Y drive circuit 24 and 28. The control signals CU, CD, LU and LD, which are output by the control signal generation circuit 32, are supplied to the simultaneous ON prevention circuit via relatively long wires. In other words, the simultaneous ON prevention circuit 34 is disposed in a stage immediately before and adjacent to the main drive circuit MDR in the X and Y electrode drive circuit, so even if noise is superimposed on the control signal wire at the upstream thereof, at least the first and second switches Q1 and Q2, the first and fourth switches Q1 and Q4, and the second and third switches Q2 or Q3 in the main driver circuit simultaneously turning ON can be prevented. Furthermore, according to the simultaneous ON prevention circuit in FIG. 4 and FIG. 5, a simultaneous ON of the third and fourth switches Q3 and Q4 can also be prevented. FIG. 10 and FIG. 11 show such examples.

FIG. 10 is a fourth block diagram of an X and Y electrode drive circuit according to the present embodiment. FIG. 10 shows an example when the X and Y electrode drive circuit in FIG. 3 is applied to FIG. 1. The data processing circuit 31 and the control signal generation circuit 32 in FIG. 3 are disposed in a drive control circuit 22 in the previous stage of control signal wires 221 and 222, and a pre-drive circuit PDR comprised of a buffer circuit 38, simultaneous ON prevention circuit 34 and amplifier AMP, is disposed in the X and Y electrode drive circuit. The configuration of a main drive circuit MDR is the same as FIG. 3.

In the case of FIG. 10, four control signals CU, CD, LU and LD propagate through relative long signal wires 221 and 222 from the drive control circuit 22, as shown in FIG. 1. During this propagation, the L level and the H level of the control signals may be inverted by the influence of noise. However the simultaneous ON prevention circuit 34 is disposed in a stage immediately before and adjacent to the main drive circuit MDR, so an undesirable combination of the four control signals becoming a simultaneous ON control state can be prevented. As a result, an undesirable combination of the four switch elements Q1 to Q4 in the main drive circuit MDR becoming a simultaneous ON state can be prevented.

The X and Y electrode drive circuit shown in FIG. 7 can also be applied to FIG. 1, just like the case described above.

FIG. 11 is a fifth block diagram of an X and Y electrode drive circuit according to the present embodiment. FIG. 11 shows an example when the X and Y electrode drive circuit in FIG. 8 is applied to FIG. 1. The data processing circuit 31 and the control signal generation circuit 32 in FIG. 8 are disposed in a drive control circuit 22 in the previous stage of control signal wires 221 and 222, and a pre-drive circuit PDR comprised of a buffer circuit 38, simultaneous ON prevention circuit 34, modulation circuit 37, insulation circuit 50, demodulation circuit 51 and amplifier AMP, is disposed in the X and Y electrode drive circuit. The configuration of a main drive circuit MDR is the same as FIG. 8.

As described above, according to the present embodiments, the simultaneous ON prevention circuit is disposed in a stage immediately before and adjacent to the main drive circuit, so the control signals for controlling the switch elements in the main drive circuit becoming an undesirable simultaneous ON control state due to noise can be prevented. Therefore it is preferable to dispose this simultaneous ON prevention circuit in a stage immediately before and adjacent to the main drive circuit in the plasma display device.

What is claimed is:

1. A plasma display device, comprising:
a plasma display panel including a plurality of display electrodes; and
an electrode drive unit which applies a drive pulse to the display electrodes a plurality of times, wherein
the electrode drive unit comprises: a main drive circuit which applies the drive pulse to the display electrodes; a pre-drive circuit which supplies control signals to the main drive circuit; and a drive control circuit which supplies a drive waveform information signal to the pre-drive circuit,
the main drive circuit comprises: a first switch which is connected between a first power supply and the display electrode, and turns ON when the drive pulse rises; a second switch which is connected between a second power supply lower than the first power supply, and the display electrode, and turns ON when the drive pulse falls; a charge collection capacitor; a third switch which is disposed between the charge collection capacitor and display electrode, and turns ON when the drive pulse rises; and a fourth switch which is disposed between the display electrode and charge collection capacitor, and turns ON when the drive pulse falls, and
the pre-drive circuit comprises: a control signal generation circuit which generates first to fourth control signals for controlling the first to fourth switches respectively based on the drive waveform information signal; and a simultaneous ON prevention circuit which disables at least a set of the first and second control signals, a set of the first and fourth control signals, and a set of the second and third control signals, out of the first to fourth control signals, to be a simultaneous ON control state respectively, and supplies the first to fourth control signals to the main drive circuit.

2. The plasma display device according to claim 1, wherein a wire length for the control signal between the simultaneous ON prevention circuit and main drive circuit is shorter than a wire length for the drive waveform information signal between the drive control circuit and pre-drive circuit.

3. The plasma display device according to claim 1, wherein the simultaneous ON prevention circuit is disposed adjacent to the main drive circuit.

4. The plasma display device according to claim 1, wherein the main drive circuit has a first inductor between the third switch and the display electrode, and a second inductor between the fourth switch and the display electrode respectively.

5. The plasma display device according to claim 1, wherein the simultaneous ON prevention circuit:
outputs the first control signal in OFF control state, even if the first control signal, generated by the control signal generation circuit, is in ON control state, when either the second or fourth control signal, generated by the control signal generation circuit, is in ON control state;
outputs the second control signal in OFF control state, even if the second control signal, generated by the control signal generation circuit, is in ON control state, when either the first or third control signal, generated by the control signal generation circuit, is in ON control state;
outputs the third control signal in OFF control state, even if the third control signal, generated by the control signal generation circuit, is in ON control state, when either the second or fourth control signal, generated by the control signal generation circuit, is in ON control state; and
outputs the fourth control signal in OFF control state, even if the fourth control signal, generated by the control signal generation circuit, is in ON control state, when either the first or third control signal, generated by the control signal generation circuit, is in ON control state.

6. A plasma display device, comprising:
a plasma display panel including a plurality of display electrodes; and
an electrode drive unit which applies a drive pulse to the display electrodes a plurality of times, wherein
the electrode drive unit comprises: a main drive circuit which applies the drive pulse to the display electrodes; and a pre-drive circuit which supplies control signals to the main drive circuit,
the main drive circuit comprises: a first switch which is connected between a first power supply and the display electrode, and turns ON when the drive pulse rises; a second switch which is connected between a second power supply lower than the first power supply, and the display electrode, and turns ON when the drive pulse falls; a charge collection capacitor; a third switch which is disposed between the charge collection capacitor and display electrode, and turns ON when the drive pulse rises; and a fourth switch which is disposed between the display electrode and charge collection capacitor, and turns ON when the drive pulse falls, and
the pre-drive circuit comprises: a control signal generation circuit which generates first to fourth control signals for controlling the first to fourth switches based on the drive waveform information signal; and a simultaneous ON prevention circuit which disables at least a set of the first and second control signals, a set of the first and fourth control signals, and a set of the second and third control signals, out of the first to fourth control signals, to be a simultaneous ON control state respectively, and supplies the first to fourth control signals to the main drive circuit.

7. The plasma display device according to claim 6, wherein the simultaneous ON prevention circuit is disposed adjacent to the main drive circuit.

8. The plasma display device according to claim 6, wherein the simultaneous ON prevention circuit:
outputs the first control signal in OFF control state, even if the first control signal, generated by the control signal generation circuit, is in ON control state, when either the second or fourth control signal, generated by the control signal generation circuit, is in ON control state;
outputs the second control signal in OFF control state, even if the second control signal, generated by the control signal generation circuit, is in ON control state, when either the first or third control signal, generated by the control signal generation circuit, is in ON control state;
outputs the third control signal in OFF control state, even if the third control signal, generated by the control signal generation circuit, is in ON control state, when either the second or fourth control signal, generated by the control signal generation circuit, is in ON control state; and
outputs the fourth control signal in OFF control state, even if the fourth control signal, generated by the control signal generation circuit, is in ON control state, when either the first or third control signal, generated by the control signal generation circuit, is in ON control state.

9. A plasma display device, comprising:
a plasma display panel including a plurality of display electrodes; and
an electrode drive unit which applies a drive pulse to the display electrodes a plurality of times, wherein
the electrode drive unit comprises: a main drive circuit which applies the drive pulse on the display electrodes; a pre-drive circuit which supplies control signals to the main drive circuit; and a drive control circuit which supplies a drive waveform information signal to the pre-drive circuit,
the main drive circuit comprises: a charge collection capacitor; and a plurality of switches which generate the drive pulse,
the pre-drive circuit comprises: a control signal generation circuit which generates a plurality of control signals for controlling the plurality of switches based on the drive waveform information signal; and a simultaneous ON prevention circuit which disables at least a predetermined control signal pair out of the plurality of control signals to be a simultaneous ON control state, and supplies the plurality of control signals to the main drive circuit, and
a wire length for the control signal between the simultaneous ON prevention circuit and main drive circuit is shorter than a wire length for the drive waveform information signal between the drive control circuit and pre-drive circuit.
